(19) United States
(12) Patent Application Publication
(10) Pub. No.: US 2025/0322270 A1
(43) Pub. Date: Oct. 16, 2025

(54) METHOD AND SYSTEM OF GENERATING KNOWLEDGE GRAPH OF DATA REPOSITORY

(71) Applicant: Quantiphi, Inc., Marlborough, MA (US)

(72) Inventors: Dagnachew Birru, Marlborough, MA (US); Ganesh Laxman Parab, Mumbai (IN); Zishan Ahmad, Mumbai (IN); Vishal Vaddina, Toronto, Ontario (CA)

(21) Appl. No.: 19/251,316

(22) Filed: Jun. 26, 2025

(51) Int. Cl. G06N 5/022; G06F 16/21

(52) U.S. Cl. CPC G06N 5/022; G06F 16/212

(57) ABSTRACT

A method (400) and system (100) of generating knowledge graph of the data repository is disclosed. The method (400) includes receiving input data (302) and access of data repository (304). The method (400) may include generating semantic (310) representation of data repository (304) schema based on input data (302) and data repository (304) using language model. The method (400) may further include validating semantic representation (310) syntactically and with respect to input data (302). The method (400) may further include generating mapping (320) file of data repository (304) schema based on semantic representation (310) and data repository (304) using language model. The mapping file (320) may include mapping of plurality of elements of semantic representation (310) to corresponding elements in input data (302). Further, the method (400) includes validating mapping file (320) syntactically and semantically based on semantic representation (310), data repository (304) and input data (302).

### FIELD OF THE INVENTION

The present disclosure relates to Natural Language Processing (NLP), and more specifically to a method and system of generating knowledge graph of a data repository.

### BACKGROUND OF THE INVENTION

The increase of data across industries has significantly amplified the need for systems that can derive structured insights from unstructured knowledge repositories. Enterprises today rely heavily on Natural Language Processing (NLP) and semantic technologies to interpret, link, and retrieve meaningful data from complex datasets. Knowledge graphs (KGs) have emerged as a powerful tool to represent relationships between entities in a format that is both machine-readable and contextually rich. The knowledge graphs are essential for various domains, including search engines, recommendation systems, and enterprise analytics. However, the power of knowledge graphs is often limited by the complexity of querying them, which typically requires knowledge of SPARQL or other graph-based query languages that are not user-friendly for most analysts or business users.

Despite the advantages, interacting with knowledge graphs remains non-trivial for users who are familiar only with traditional relational databases. Structured Query Language (SQL) remains the dominant query language used across organizations due to its ubiquity and ease of use. There is a critical gap in enabling users to query semantic-rich knowledge graphs using familiar SQL syntax while still leveraging the inferencing and relationship capabilities of knowledge graphs. This is especially relevant in enterprise settings where business analysts and decision-makers rely on SQL-based tools for day-to-day reporting and analysis but miss out on the deeper relational insights captured in knowledge graphs.

Moreover, conventional solutions attempt to bridge this gap by offering limited SQL-like interfaces over knowledge graph engines or by requiring complex intermediate data modelling. The approaches often fail to capture the full semantics of the underlying graph or require users to learn new paradigms that blend SQL with graph logic, ultimately defeating the purpose of simplicity. Some tools translate SQL to SPARQL but lose the efficiency or reasoning capabilities inherent in native graph queries. Others require duplicating data between relational and graph systems, leading to maintenance overhead and inconsistencies.

There is therefore a pressing need for a unified solution that allows users to query knowledge graphs directly using standard SQL while abstracting the complexities of graph traversal and semantic querying. Such a solution should integrate the reasoning power of knowledge graphs with the simplicity of SQL, enabling domain users to extract richer insights from the data without learning new query languages or dealing with integration burdens.

### SUMMARY

The following embodiments presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide computer-implemented method of generating knowledge graph of a data repository, the method may include receiving an input data and an access of the data repository. The method may further include generating a semantic representation of a data repository schema based on the input data and the data repository using a language model. The semantic representation includes a plurality of elements, and the semantic representation incorporates domain or task specific logics. The method may further include validating the semantic representation syntactically and with respect to the input data. The method may further include generating a mapping file of the data repository schema based on the semantic representation and the data repository using the language model. The mapping file includes a mapping of the plurality of elements of the semantic representation to corresponding elements in the input data. Further, the method includes validating the mapping file syntactically and semantically based on the semantic representation, data repository and the input data.

According to some example embodiments, wherein the semantic representation is a graph-based or knowledge-based abstraction of the data repository schema.

According to some example embodiments, wherein the domain or task specific logics are integrated into the semantic representation based on the input data and the validation of the semantic representation.

According to some example embodiments, wherein the structural and syntactic integrity of the semantic representation and the mapping file is checked by a plurality of predefined rules.

According to some example embodiments, wherein the language model is a large language model (LLM) trained to process structured prompts and domain knowledge.

According to some example embodiments, wherein the semantic representation of the data repository schema is generated by a LLM based ontology generation agent, and wherein the mapping file of the data repository schema is generated by a LLM based mapping generation agent.

According to some example embodiments, wherein the semantic representation and the mapping file are iteratively refined using feedback loops with the language model until the semantic representation and mapping file meets a predefined validation criterion. The feedback loops may include one or more iterations of the validation of the semantic representation and the validation of the mapping file.

Some example embodiments disclosed herein provide a computer-implemented system of generating knowledge graph of a data repository. The computer-implemented system includes a processor, and a memory communicatively coupled to the processor. The memory stores processor-executable instructions, which, on execution, cause the processor to receive an input data and an access of the data repository. The processor further generate a semantic representation of a data repository schema based on the input data and the data repository using a language model. The semantic representation includes a plurality of elements, and the semantic representation incorporates domain or task specific logics. The processor further validate the semantic representation syntactically and with respect to the input data. The processor further generate a mapping file of the data repository schema based on the semantic representation and the data repository using the language model. The mapping file includes a mapping of the plurality of elements of the semantic representation to corresponding elements in the input data. Further, the processor may validate the mapping file syntactically and semantically based on the semantic representation, data repository and the input data.

Some example embodiments disclosed herein provide a non-transitory computer readable medium having stored thereon computer executable instruction which when executed by one or more processors, cause the one or more processors to carry out a method of generating knowledge graph of a data repository, the method includes receiving an input data and an access of the data repository. The method further includes generating a semantic representation of a data repository schema based on the input data and the data repository using a language model. The semantic representation includes a plurality of elements, and the semantic representation incorporates domain or task specific logics. The method further includes validating the semantic representation syntactically and with respect to the input data. The method further includes generating a mapping file of the data repository schema based on the semantic representation and the data repository using the language model. The mapping file includes a mapping of the plurality of elements of the semantic representation to corresponding elements in the input data. Further, the method includes validating the mapping file syntactically and semantically based on the semantic representation, data repository and the input data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The above and still further example embodiments of the present invention will become apparent upon consideration of the following detailed description of embodiments thereof, especially when taken in conjunction with the accompanying drawings, and wherein:

FIG. 1 is a block diagram of an environment of a system for generating knowledge graph of a data repository, in accordance with an example embodiment.

FIG. 2 is a block diagram illustrating various modules within a memory of a computing device configured for generating the knowledge graph of the data repository, in accordance with an example embodiment.

FIG. 3A illustrates a block diagram of a system architecture for generating knowledge graph of the data repository, in accordance with an example embodiment.

FIG. 3B illustrates a block diagram of a system architecture for converting a NL query to a SQL query, in accordance with an example embodiment.

FIG. 4 illustrate a flow diagram of a method for generating the knowledge graph of the data repository, in accordance with an example embodiment.

FIG. 5 is a block diagram of an exemplary computer system for implementing embodiments consistent with the present disclosure.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present invention. It will be apparent, however, to one skilled in the art that the present invention can be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

### Definitions

The term “Ontology” may refer to a formal representation of concepts, entities, relationships, and rules within a specific domain, designed to enable both humans and machines to understand, integrate, and query data meaningfully.

The term “Mapping file” may refer to a structured specification that defines how elements in a relational database (tables, columns, and values) correspond to elements in an ontology-based knowledge graph (classes, properties, and relationships).

The term “Large Language Model (LLM)” may be used to refer to a type of artificial intelligence model that is trained on vast amounts of text data to understand, generate, and interact using human language. The LLMs are designed to predict and generate text based on input prompts, enabling a wide range of language-related tasks such as text generation, translation, code generation, etc.

The term “Structured Query Language (SQL)” may refer to a standardized programming language used to store, retrieve, manage, and manipulate data in relational databases. The SQL allows users to create and modify database structures (schemas), query data, insert/update/delete records, and control access to the data.

The term “Structured Protocol and Resource Description Framework (RDF) Query Language (SPARQL)” may refer to a standardized query language and protocol used to retrieve and manipulate data stored in Resource Description Framework (RDF) format, typically within semantic web or knowledge graph systems.

The term “module” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

### End of Definitions

Natural Language to SQL (NL2SQL) generation systems face significant challenges in enterprise-scale databases with complex schemas involving multiple tables and intricate join operations. A prevalent issue is hallucination, where generated SQL queries fail to accurately reflect the database structure or business context, leading to incorrect or inefficient results. Conventional approaches struggle to handle complicated joins and conditions, especially when business-specific use cases are involved. Moreover, creating ontologies and mapping files to bridge database schemas and business logic requires significant expertise, which business users often lack, while developers may not fully understand domain-specific requirements. The gap hinders the effective generation of accurate, context-aware SQL queries for large-scale, relational databases.

The present disclosure addresses these challenges by introducing multi-agent pipeline to address the challenges. The first pipeline employs an ontology generation agent to convert database schemas and metadata into a knowledge graph-based ontology, incorporating user-provided business descriptions. A mapping generation agent creates R2RML mapping files to link ontology nodes to database elements. Both agents are supported by a data access agent for seamless interaction with data sources. Verification agents iteratively refine the ontology and mappings for syntactic and semantic accuracy, integrating human feedback to align with business use cases. The second pipeline leverages the ontology to convert natural language queries into SPARQL, which is then transformed into precise SQL queries using a rule-based converter. The approach enhances query accuracy and efficiency, outperforming standard NL2SQL methods by effectively handling complex joins and business logic.

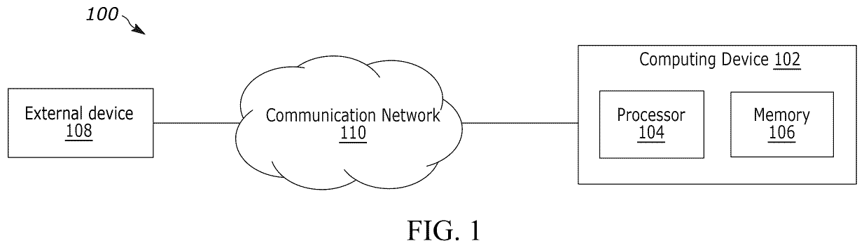

Embodiments of the present disclosure may provide a method, a system, and a computer program product for generating knowledge graph for the NL to the SQL translation. The method, the system, and the computer program product generates ontology and knowledge graph for the NL to the SQL translation in such an improved manner are described with reference to FIG. 1 to FIG. 5 as detailed below.

FIG. 1 illustrates a block diagram of an environment of a system 100 for generating ontology and knowledge graph for the NL to the SQL translation, in accordance with an example embodiment. The system 100 is designed to facilitate efficient and accurate generation of ontology and mapping files by utilizing LLMs. The system 100 includes a computing device 102 and an external device 108. The computing device 102 may be communicatively coupled with the external device 108 via a communication network 110. Examples of the computing device 102 may include, but are not limited to, a server, a desktop, a laptop, a notebook, a tablet, a smartphone, a mobile phone, an application server, or the like.

The communication network 110 may be wired, wireless, or any combination of wired and wireless communication networks, such as cellular, Wi-Fi, internet, local area networks, or the like. In one embodiment, the communication network 110 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The computing device 102 may include a memory 106, and a processor 104. The term “memory” used herein may refer to any computer-readable storage medium, for example, volatile memory, random access memory (RAM), non-volatile memory, read only memory (ROM), or flash memory. The memory 106 may include a Random-Access Memory (RAM), a Read-Only Memory (ROM), a Complementary Metal Oxide Semiconductor Memory (CMOS), a magnetic surface memory, a Hard Disk Drive (HDD), a floppy disk, a magnetic tape, a disc (CD-ROM, DVD-ROM, etc.), a USB Flash Drive (UFD), or the like, or any combination thereof.

The term “processor” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The processor 104 may retrieve computer program code instructions that may be stored in the memory 106 for execution of the computer program code instructions. The processor 104 may be embodied in a number of different ways. For example, the processor 104 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 104 may include one or more processing cores configured to perform independently. A multi-core processor may enable multiprocessing within a single physical package. Additionally, or alternatively, the processor 104 may include one or more processors configured in tandem via the bus to enable independent execution of instructions, pipelining, and/or multithreading.

Additionally, or alternatively, the processor 104 may include one or more processors capable of processing large volumes of workloads and operations to provide support for big data analysis. In an example embodiment, the processor 104 may be in communication with a memory 106 via a bus for passing information among components of the system 100.

The memory 106 may be non-transitory and may include, for example, one or more volatile and/or non-volatile memories. In other words, for example, the memory 106 may be an electronic storage device (for example, a computer readable storage medium) comprising gates configured to store data (for example, bits) that may be retrievable by a machine (for example, a computing device like the processor 104). The memory 106 may be configured to store information, data, contents, applications, instructions, or the like, for enabling the apparatus to carry out various functions in accordance with an example embodiment of the present disclosure. For example, the memory 106 may be configured to buffer input data for processing by the processor 104.

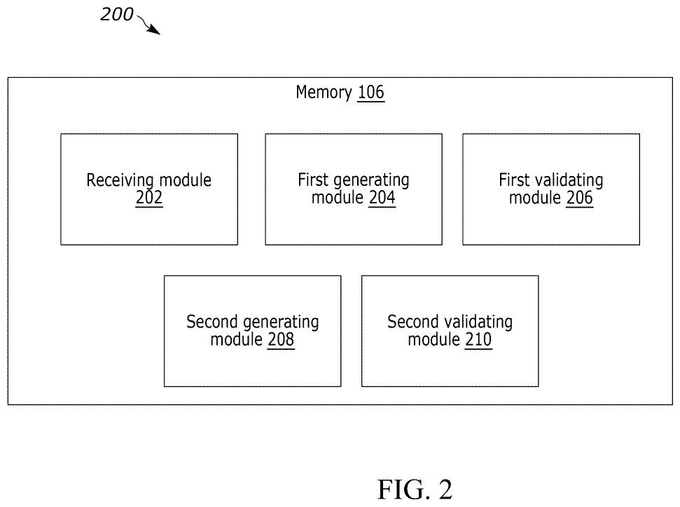

The computing device 102 may be capable of generating the knowledge graph of the data repository. The memory 106 may store instructions that, when executed by the processor 104, cause the computing device 102 to perform one or more operations of the present disclosure which will be described in greater detail in conjunction with FIG. 2. The computing device 102 is responsible for receiving an input data and an access of the data repository. The computing device 102 is further responsible for generating a semantic representation of a data repository schema based on the input data and the data repository using a language model. The semantic representation includes a plurality of elements, and the semantic representation incorporates domain or task specific logics. Further, the computing device 102 is responsible for validating the semantic representation syntactically and with respect to the input data. The computing device 102 is responsible for generating a mapping file of the data repository schema based on the semantic representation and the data repository using the language model. The mapping file includes a mapping of the plurality of elements of the semantic representation to corresponding elements in the input data. Further, the computing device 102 is responsible for validating the mapping file syntactically and semantically based on the semantic representation, data repository and the input data.

The external devices 108 may refers to various hardware and software tools that may be integrated with the system 100 to enhance its functionality. These devices may include database. The database is essential for generating ontology and mapping files according to business use case. The complete process followed by the system 100 is explained in detail in conjunction with FIG. 2 to FIG. 5.

FIG. 2 illustrates a block diagram 200 illustrating various modules within the memory 106 of the computing device 102 configured for generating the knowledge graph for the NL to the SQL translation, in accordance with an example embodiment. The memory 106 may include a receiving module 202, a first generating module 204, a first validating model 206, a second generating module 208, and a second validating module 210.

The receiving module 202 is responsible for receiving an input data and an access of the data repository. The input data may consist of user-provided information, typically a business description or logic, which outlines the context, use case, or domain-specific requirements for the database. For example, in a school database scenario, the business description might detail the need to analyse student enrolment, Free and Reduced Price Meal (FRPM) program eligibility, and SAT scores in relation to specific counties or grade levels. Further, the access of the data repository grants permission to interact with the database or its metadata, such as schema details (e.g., tables, columns, relationships like foreign keys) for a relational database like the “california_schools” dataset mentioned in the documents. The data repository typically refers to a relational database or its metadata, which includes table structures, column names, data types, primary and foreign key relationships, and constraints. In an embodiment, the receiving module 202 establishes or receives credentials, connection strings, or API endpoints to access the database. For example, the receiving module 202 may connect to a SQL database like “california_schools” to retrieve the schema or metadata, such as the structure of the database such as CDSCode, Academic Year, Enrolment, etc.

The first generating module 204 is configured to generate a semantic representation of a data repository schema based on the input data and the data repository using a language model. The semantic representation may include a plurality of elements, and the semantic representation incorporates domain or task specific logics. In an aspect, the semantic representation may be the ontology of the data repository schema. The semantic representation is a graph-based or knowledge-based abstraction of the data repository schema. The language model may be a Large Language Model (LLM) trained to process structured prompts and domain knowledge. The LLM may be pre-trained on diverse datasets, including text, structured data, and possibly domain-specific corpora such as business rules, database schemas. The LLM is fine-tuned to handle structured prompts combinations of the business description and schema details, enabling the LLM to interpret and synthesize technical and contextual information. The first generating module 204 feeds the LLM a structured prompt, which may combine the business description (e.g., “Track FRPM participation for high school grades in Amador County”) with schema details (e.g., “schools.CDSCode links to frpm.CDSCode, frpm has Low_Grade and High_Grade”). The LLM analyses the inputs to identify relationships, entities, and domain-specific patterns. The first generating module 204 provide an output which may be a semantic representation, described as a graph-based or knowledge-based abstraction of the data repository schema. The representation captures not just the structure (tables, columns, relationships) but also the meaning and intent behind the data, informed by domain-specific logic. In an embodiment, as a graph-based abstraction, the representation uses nodes (entities) and edges (relationships) to model the schema. For instance, the foreign key relationship between “schools.CDSCode” and “frpm.CDSCode” becomes the “:hasFRPM” edge in the ontology.

The first validating model 206 is configured to validate the semantic representation syntactically and with respect to the input data. The structural and syntactic integrity of the semantic representation is checked by a plurality of predefined rules. In an embodiment, the semantic representation is iteratively refined using feedback loops with the language model until the semantic representation meets a predefined validation criterion, and the feedback loops includes one or more iterations of the validation of the semantic representation. In an embodiment, the first validating module 206 verifies the integrity and correctness of the semantic representation produced from the data repository schema and business description. The first validating module 206 ensures the ontology is structurally sound, syntactically correct, and aligned with the domain-specific logic provided by the user. The predefined rules may include syntax compliance, consistency, completeness, and structural integrity. In some embodiments, the first validating module 206 compares the ontology to the business description to confirm relevance and accuracy. For example, if the business description emphasizes FRPM analysis for grades 9-12 in Amador County, the first validating module 206 checks presence of relevant entities (e.g., “:schools,” “:frpm”). Further, the first validating module 206 checks an inclusion of key relationships such as “:hasFRPM” linking schools to FRPM data. The first validating module 206 further checks correct attributes such as “:Low_Grade” and “:High_Grade” to capture grade ranges, “:County” to filter by “Amador”. Finally, the first validating module 206 verifies that domain-specific rules are embedded, such as prioritizing high school grades or specific counties, ensuring the ontology reflects the intended use case rather than just the raw schema.

In an embodiment, the second generating module 208 is configured to generate a mapping file of the data repository schema based on the semantic representation and the data repository using the language model. The mapping file may include a mapping of the plurality of elements of the semantic representation to corresponding elements in the input data. The mapping file serves as a critical link, enabling the system to translate queries or relationships defined in the ontology (e.g., in SPARQL) back to the relational database structure (e.g., for SQL queries). By incorporating the business context and schema details, the second generating module 208 ensures the mapping is both technically accurate and aligned with domain-specific requirements. The mapping file is a structured document that maps elements of the semantic representation to corresponding elements in the data repository schema. In an example, R2RML (RDB to RDF Mapping Language) file, a standard for linking relational databases to RDF-based ontologies. The mapping file connects the plurality of elements in the ontology to their counterparts in the database. For example, entities to Tables such as the ontology node “:schools” maps to the “california_schools.schools” table, Attributes to Columns such as the data property “:CDSCode” maps to the “CDSCode” column in the “schools” table, with a datatype like “xsd:string.”, and relationships to joins such as relationship “:hasFRPM” implies a join between “schools” and “frpm” tables via the “CDSCode” foreign key.

In some embodiments, the LLM processes the ontology and data repository schema, often via a structured prompt combining both such as “Map ontology node :schools to table schools, property :CDSCode to column CDSCode”. The LLM leverages its understanding of relationships, datatypes, and context to generate accurate mappings, accounting for complexities like joins or data type consistency. Further, The LLM analyses the ontology structure (nodes, relationships, attributes) and schema (tables, columns, relationships), producing an initial mapping file.

The second validating module 210 is configured to validate the mapping file syntactically and semantically based on the semantic representation, data repository and the input data. The mapping file are iteratively refined using feedback loops with the language model until mapping file meets a predefined validation criterion. The feedback loops include one or more iterations of the validation of the semantic representation and the validation of the mapping file. The second validating module 210 verifies the integrity and correctness of the mapping file, which links the semantic representation (e.g., ontology) to the data repository schema. The validation ensures the mapping file is structurally sound, adheres to syntax rules, and aligns with the semantic representation, data repository, and domain-specific input data. Through iterative refinement, the second validating module 210 produces a robust mapping file, critical for accurate SPARQL-to-SQL conversion and effective query execution in enterprise-scale databases. The second validating module 210 verifies the mapping file follows R2RML rules, such as correct use of “rr:TriplesMap,” “rr:logicalTable,” “rr:subjectMap,” and “rr:predicateObjectMap.” For example, “map:TripleMap_Schools” must properly define “rr:tableName ‘california_schools.schools’.” Further, the second validating module 210 ensures no duplicate or conflicting mappings (e.g., “:CDSCode” mapped to “CDSCode” consistently across tables) exist in the mapping file and checks that mappings align with the database schema, e.g., referenced columns (like “CDSCode”) exist in the specified tables. In some embodiments, the second validating module 210 may verifies that ontology elements are correctly mapped to database elements, confirms mapped columns and tables exist and match the schema, and ensures the mapping file supports the business description.

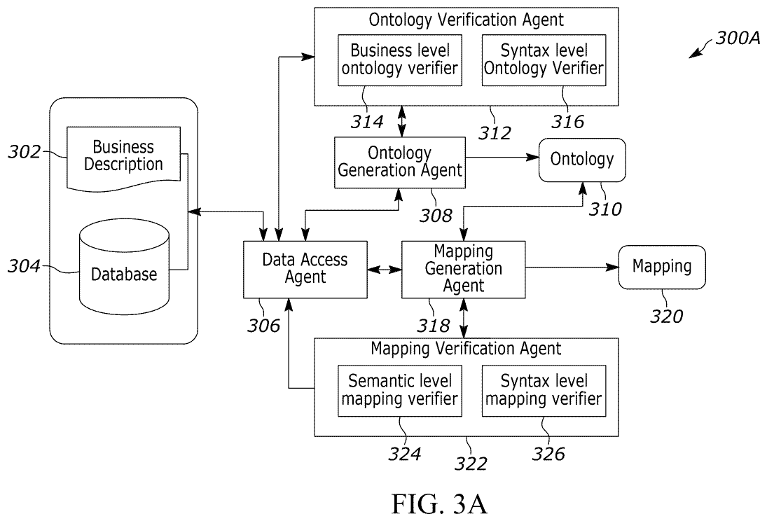

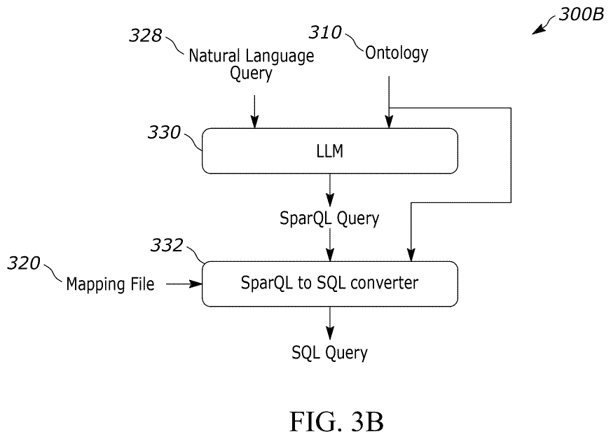

FIG. 3A illustrates a block diagram of a system architecture 300A for generating knowledge graph for the NL to the SQL translation, in accordance with an example embodiment. The system architecture 300A may include a business description 302, a database 304, a Data access agent 306, an ontology generation agent 308, an ontology verification agent 312, a mapping generation agent 318, and a mapping verification agent 322.

In an embodiment, the data access agent 306 may act as an intermediary that ensures efficient, secure, and structured access to heterogeneous data sources, enabling the ontology generation agent 308, the mapping generation agent 318, the ontology verification agent 312, and the mapping verification agent 322 to perform their respective tasks effectively. By centralizing data access, the data access agent 306 eliminates redundant interactions with the database 304 and business description 302, ensuring consistency and reducing computational overhead. The database 304 may be a relational database that stores structured data, such as school-related information. The database 304 may include schema details like table structures, columns, primary/foreign keys, and metadata, which define relationships and constraints. The database 304 serves as the data source for ontology and mapping generation, enabling the system to understand its structure for query processing. The business description 302 may be a user-provided input outlining the business context and use case of the database. For example, it might specify that the database is used for analysing school performance in California, focusing on metrics like free/reduced meal programs (FRPM) and SAT scores for grades 9-12. The business description 302 may include business logic, such as prioritizing certain relationships (e.g., schools with specific counties) or conditions, which guides the ontology generation to align with domain-specific requirements, reducing irrelevant or incorrect interpretations in query generation.

In some embodiments, the data access agent 306 processes the business description 302 and the database 304 to extract relevant information, such as table structures, column relationships, primary and foreign key constraints, and business-specific rules or conditions. Further, the data access agent 306 may serves as a bridge, responding to requests from other agents by providing tailored data subsets or metadata required for ontology generation, mapping file creation, and verification processes.

Further, the ontology generation agent 308 automates the creation of a knowledge graph ontology 310 from a relational database 304 schema and user-provided business description 302. The primary function of the ontology generation agent 308 is to transform the structural and contextual information of a database 304 into a semantic ontology 310, represented in a standardized format such as Web Ontology Language (OWL). The ontology 310 captures entities (e.g., schools, FRPM programs, SAT scores), the relationships (e.g., hasFRPM, hasSATScores), and associated data properties (e.g., Academic_Year, AvgScrMath), enabling the system to understand and navigate complex database 304 relationships at a semantic level for improved query generation. In an embodiment, the ontology generation agent 308 operates by interfacing with the data access agent 306 to retrieve the database 304 schema, metadata, and business description 302. The schema provides structural details, such as tables (frpm, satscores), columns (CDSCode, AvgScrMath), and constraints (e.g., foreign keys linking CDSCode across tables), while the business description 302 provides contextual information, such as the database's 304 use case (e.g., analyzing school performance in California) and relevant business logic (e.g., focusing on grades 9-12). The ontology generation agent 308 processes the inputs to generate an initial ontology. For example, it identifies schools as a class, defines object properties like hasFRPM to link schools to frpm, and assigns data properties like AvgScrMath with appropriate datatypes (e.g., xsd:float). The ontology generation agent 308 may employs natural language understanding to interpret the business description 302, ensuring the ontology 310 reflects domain-specific semantics.

In an embodiment, the ontology verification agent 312 may iteratively validate the ontology 310 produced by the ontology generation agent 308, performing syntactic and semantic checks to guarantee compliance with ontology standards (e.g., OWL syntax) and alignment with the user-provided business description 302. The ontology verification agent 312 may include a business level ontology verifier 314 and a syntax level ontology verifier 316. The business level ontology verifier 314 conducts semantic validation by cross-referencing the ontology 310 against the business description 302 and database 304 metadata, accessed via the data access agent 306. For example, if the business description 302 emphasizes analysing schools in California for grades 9-12, the business level ontology verifier 314 verifies that the ontology 310 includes relevant relationships (e.g., hasFRPM linking to frpm with Low_Grade and High_Grade properties) and excludes irrelevant entities. Further, the syntax level ontology verifier 316 performs syntactic verification to ensure the ontology 310 adheres to formal standards, such as checking for correct OWL syntax, proper prefix definitions (e.g., xsd, rdfs), and valid class-property associations (e.g., ensuring :hasFRPM has a defined domain and range). In some embodiments, any discrepancies, such as missing relationships or incorrect datatypes (e.g., AvgScrMath not defined as xsd:float), are identified and detailed in a feedback report. The feedback report is then transmitted back to the ontology generation agent 308, which uses it to refine the ontology 310 iteratively. The ontology verification agent 308 employs rule-based validation algorithms for syntactic checks, ensuring deterministic and reproducible results, while semantic validation leverages natural language processing (NLP) techniques to interpret the business description 302 and map its intent to the ontology's structure.

In an embodiment, the mapping generation agent 318 automate the creation of R2RML (RDB to RDF Mapping Language) mapping 320 files. The mapping generation agent 318 establish precise relationships between the relational database 304 schema and the ontology 310 generated by the ontology generation agent 308, enabling seamless translation of SPARQL queries into SQL queries. The mapping 320 file defines how database 304 tables, columns, and values correspond to ontology 310 entities, properties, and relationships. In an embodiment, the mapping generation agent 318 operates by interfacing with the data access agent 306 to retrieve the database 304 schema (e.g., tables like frpm and satscores, with columns such as CDSCode and AvgScrMath) and the ontology 310, which includes classes (e.g., schools), object properties (e.g., hasFRPM), and data properties (e.g., AvgScrMath with datatype xsd:float). Using the LLM, the mapping generation agent 318 analyses the inputs to generate an R2RML mapping file. For instance, it maps the schools table to the school's class in the ontology 310, creating a triples map (e.g., map:TripleMap_Schools) that links the table's CDSCode column to the ontology's CDSCode property via a subject map (e.g., rr:template “http://example.org/schools/{CDSCode}”) and predicate-object maps (e.g., mapping AvgScrMath column to voc:AvgScrMath with datatype xsd:float).

Further, the mapping verification agent 322 validate the mapping file produced by the Mapping Generation Agent, ensuring it accurately defines the relationships between the database schema and the ontology's nodes and relationships. The mapping verification agent 322 may include a semantic level mapping verifier 324 and a syntax level mapping verifier 326. The semantic level mapping verifier 324 validates the mappings 320 against the ontology 310, database 304 metadata, and business description 302, ensuring that the mappings 320 align with the intended relationships. For example, the semantic level mapping verifier 324 confirms that the mapping of AvgScrMath to voc:AvgScrMath with datatype xsd:float corresponds to the ontology's definition and the database's column type, and that the business context (e.g., focusing on school performance metrics) is reflected in the mapped relationships, such as hasSATScores. Further, the syntax level mapping verifier 326 checks for compliance with R2RML standards, ensuring correct syntax, such as proper use of rr:logicalTable, rr:subjectMap, and rr:predicateObjectMap, and verifying that column references (e.g., rr:column “CDSCode”) match the database 304 schema accessed via the data access agent 306. In some embodiments, the mapping verification agent 322 generates a detailed feedback report. The feedback report is sent to the mapping generation agent 318, which iteratively refines the mapping file 320 using the LLM. The verification process leverages rule-based algorithms for syntactic checks to ensure deterministic outcomes, while semantic validation employs reasoning techniques to evaluate the logical consistency of mappings 320 against the ontology 310 and business description 302. The iterative refinement continues until the mapping 320 file meets predefined accuracy and consistency criteria.

FIG. 3B illustrates a block diagram of a system architecture 300B for converting a NL query to a SQL query, in accordance with an example embodiment. The system architecture 300B may include the ontology 310, a Natural language query 328, a LLM 330, a mapping file 320, and a SparQL to SQL converter 332.

In an embodiment, the LLM 330 may receive the natural language query 328 from a user and the ontology 310 from the ontology generation agent 308. The natural language query 328 allow users to interact with a relational database 304 without requiring expertise in SQL or database schema details. The natural language query 328 is expressed in plain, human-readable language, reflecting the user's intent to retrieve specific information from the database 304. For example, a natural language query might be: “How many schools in Amador that have a Free and Reduced Price Meal (FRPM) program covering grades 9 through 12?”. The LLM 330 processes the received inputs to generate a SPARQL query that reflects the user's intent in the context of the ontology 310. In an embodiment, the LLM 330 processes the natural language query 328 and the ontology 310 together through a structured prompt, which combines the query text with the ontology's schema. The prompt might include the ontology's structure, such as class definitions (:schools, :frpm), object properties (:hasFRPM), and data properties (:County, :Low_Grade), along with the query itself. Using its natural language understanding capabilities, the LLM 330 first parses the query to identify key entities and relationships. For example, the LLM 330 recognizes “schools” as the primary entity, “Amador” as a value for the County property, “FRPM program” as the frpm entity linked via hasFRPM, and “grades 9 through 12” as conditions on Low_Grade and High_Grade. The LLM 330 then maps the parsed elements to the ontology's structure, constructing a SPARQL query that reflects the query's intent.

Upon generating the SparQL query, the SparQL to SQL converter 332 may receive the mapping 320 file from the mapping generation agent 318 and the SparQL query from the LLM 330. The SPARQL-to-SQL converter 332 processes the SPARQL query by parsing its structure and applying transformation rules based on the ontology 310 and the mapping 320 file. In an example, the SPARQL-to-SQL converter 332 identifies the query's selection clause (SELECT (COUNT(?school) AS ?schoolCount)), which translates to a COUNT operation in SQL. The WHERE clause is then broken down into patterns: ?school rdf:type:schools indicates that ?school instances are of type schools, mapped to the california_schools.schools table; ?school:County “Amador” translates to a condition on the COUNTY column (COUNTY=‘Amador’); and ?school :hasFRPM ?frpm indicates a relationship between schools and frpm, resolved as a join on CDSCode (e.g., schools.CDSCode=frpm.CDSCode). The conditions ?frpm :Low_Grade “9” and ?frpm :High_Grade “12” map to frpm.LOW_GRADE=‘9’ and frpm.HIGH_GRADE=‘12’, respectively, as defined by the mapping file 320. The SPARQL-to-SQL converter 332 constructs the SQL query by joining the relevant tables (schools and frpm), applying the conditions, and aggregating the result.

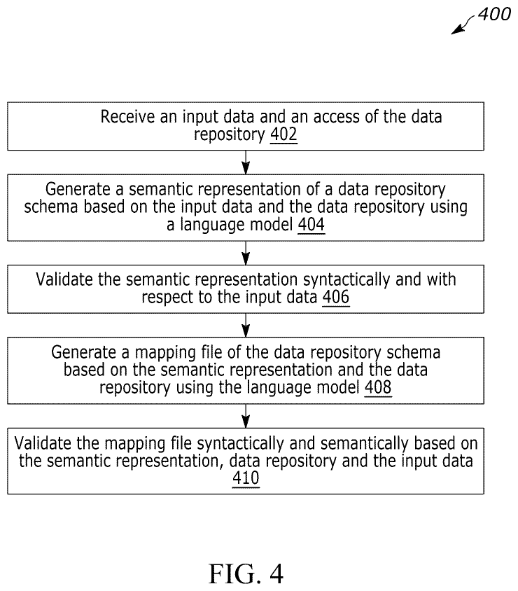

FIG. 4 illustrates a flow diagram of a method 400 for generating the knowledge graph for the NL to the SQL translation, in accordance with an example embodiment. It will be understood that each block of the flow diagram of the method 400 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 106 of the computing device 102, employing an embodiment of the present disclosure and executed by a processor 104. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

FIG. 4 is explained in conjunction with elements from FIGS. 1, 2, and 3. At step 402, an input data and an access of the data repository is received. The input data may be a business description. The input data is a user-provided textual or structured representation of the business context and use case for the database. The data repository may refer to the relational database or its metadata, which includes the schema.

At step 404, a semantic representation is generated of a data repository schema based on the input data and the data repository using a language model. The semantic representation may include a plurality of elements, and the semantic representation incorporates domain or task specific logics. The semantic representation may be an ontology in OWL format, including a plurality of elements such as entities (e.g., schools, frpm), relationships (e.g., hasFRPM), and properties (e.g., Low_Grade, County). The LLM incorporates domain or task specific logics from the user-provided business description, ensuring the ontology reflects the intended use case.

At step 406, the semantic representation is validated syntactically and with respect to the input data. Syntactic validation ensures the ontology adheres to OWL standards, checking for correct syntax, such as proper class definitions (e.g., :schools), property assignments (e.g., :hasFRPM), and prefix usage (e.g., xsd, rdfs). Simultaneously, the semantic validation is performed by cross-referencing the ontology against the input data, ensuring that entities, relationships, and properties align with the database structure.

At step 408, a mapping file of the data repository schema is generated based on the semantic representation and the data repository using the language model. The mapping file includes a mapping of the plurality of elements of the semantic representation to corresponding elements in the input data. The LLM generates mappings such as map:TripleMap_Schools, which associates ontology classes like voc:schools to database tables and maps properties like voc:AvgScrMath to columns like AvgScrMath with appropriate datatypes (e.g., xsd:float). The mapping file ensures that semantic elements are accurately tied to the corresponding data in the repository, enabling precise SPARQL-to-SQL query conversion by providing a bridge between the semantic and relational layers.

At step 410, the mapping file is validated syntactically and semantically based on the semantic representation, data repository and the input data. Syntactic validation checks the mapping file's structure against R2RML standards, verifying elements for proper syntax, and ensuring column references match the data repository's schema. Semantic validation cross-references the mapping file with the semantic representation, data repository, and input data, ensuring that mappings align with ontology-defined relationships and reflect the business context.

In some embodiments, the method 400 further includes creating a SparQL query from the ontology and the natural language query from the user. The LMM parse the natural language query and create a SparQL query based on the ontology. Further, a SparQL to SQL converter utilize the mapping file to generate a SQL query from the SparQL query. The generated SQL query may then be executed on the data repository to retrieve desired details.

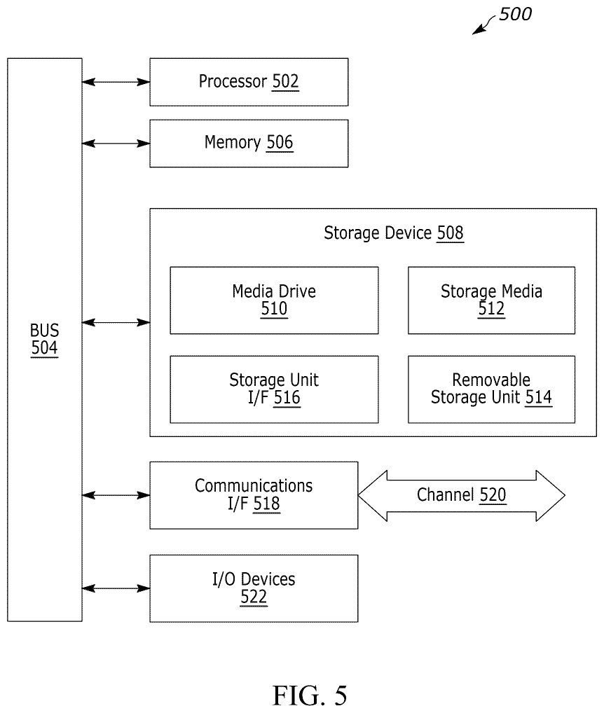

The disclosed methods and systems may be implemented on a conventional or a general-purpose computer system, such as a personal computer (PC) or server computer. Referring now to FIG. 5, an exemplary computing system 500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 500 may include one or more processors, such as a processor 502 that may be implemented using a general or special purpose processing engine such as, for example, a microprocessor, microcontroller, or other control logic. In this example, the processor 502 is connected to a bus 504 or other communication medium. In some embodiments, the processor 502 may be an Artificial Intelligence (AI) processor, which may be implemented as a Tensor Processing Unit (TPU), or a graphical processor unit, or a custom programmable solution Field-Programmable Gate Array (FPGA).

The computing system 500 may also include a memory 506 (main memory), for example, Random Access Memory (RAM) or other dynamic memory, for storing information and instructions to be executed by the processor 502. The memory 506 also may be used for storing temporary variables or other intermediate information during execution of instructions to be executed by the processor 502. The computing system 500 may likewise include a read only memory (“ROM”) or other static storage device coupled to bus 504 for storing static information and instructions for the processor 502.

The computing system 500 may also include a storage devices 508, which may include, for example, a media drive 510 and a removable storage interface. The media drive 510 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 512 may include, for example, a hard disk, magnetic tape, flash drive, or other fixed or removable medium that is read by and written to by the media drive 510. As these examples illustrate, the storage media 512 may include a computer-readable storage medium having stored there in particular computer software or data.

In alternative embodiments, the storage devices 508 may include other similar instrumentalities for allowing computer programs or other instructions or data to be loaded into the computing system 500. Such instrumentalities may include, for example, a removable storage unit 514 and a storage unit interface 516, such as a program cartridge and cartridge interface, a removable memory (for example, a flash memory or other removable memory module) and memory slot, and other removable storage units and interfaces that allow software and data to be transferred from the removable storage unit 514 to the computing system 500.

The computing system 500 may also include a communications interface 518. The communications interface 518 may be used to allow software and data to be transferred between the computing system 500 and external devices. Examples of the communications interface 518 may include a network interface (such as an Ethernet or other NIC card), a communications port (for example, a USB port, a micro-USB port), Near field Communication (NFC), etc. Software and data transferred via the communications interface 518 are in the form of signals which may be electronic, electromagnetic, optical, or other signals capable of being received by the communications interface 518. These signals are provided to the communications interface 518 via a channel 520. The channel 520 may carry signals and may be implemented using a wireless medium, wire or cable, fiber optics, or another communications medium. Some examples of the channel 520 may include a phone line, a cellular phone link, an RF link, a Bluetooth link, a network interface, a local or wide area network, and other communications channels.

The computing system 500 may include Input/Output (I/O) devices 522. Examples may include, but are not limited to a display, keypad, microphone, audio speakers, vibrating motor, LED lights, etc. The I/O devices 522 may receive input from a user and also display an output of the computation performed by the processor 502. In this document, the terms “computer program product” and “computer-readable medium” may be used generally to refer to media such as, for example, the memory 506, the storage devices 508, the removable storage unit 514, or signal(s) on the channel 520. These and other forms of computer-readable media may be involved in providing one or more sequences of one or more instructions to the processor 502 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 514, the media drive 510 or the communications interface 518. The control logic (in this example, software instructions or computer program code), when executed by the processor 502, causes the processor 502 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media. It is intended that the disclosure and examples be considered as exemplary only.

As will be appreciated by those skilled in the art, the techniques described in the various embodiments discussed above are not routine, or conventional, or well understood in the art. The techniques discussed above provide for innovative solutions to address the challenges associated with generating the knowledge graph of the data repository. The disclosed techniques offer several advantages over the existing methods:

Reduced Hallucination in NL2SQL Generation: The use of ontology and mapping files embeds business logic into query generation, significantly reducing inaccuracies caused by Large Language Model (LLM) hallucinations, especially in enterprise-scale databases with complex schemas and joins.

Automated Ontology and Mapping File Generation: The present disclosure enables semi-automated conversion of SQL schemas into ontological knowledge graphs and R2RML mappings using LLMs, reducing dependency on human expertise.

Human-in-the-Loop Enhancement: Iterative refinement via feedback (both human and agent-based) helps improve syntactic and semantic correctness of the ontology and mappings, resulting in higher precision and domain alignment.

Business Context-Aware Querying: Embedding business-specific logic into the ontology improves contextual relevance of the generated queries, tailoring them better to organizational needs.

Syntactic and Semantic Validation: The present disclosure includes dedicated verification agents for both ontology and mapping files validation, leading to high-fidelity outputs that align with both technical and domain-specific requirements.

Improved Developer and Business Collaboration: The present disclosure bridges the gap between technical developers and business users, allowing domain experts to influence ontology without needing deep technical expertise.

The disclosed techniques offer several applications including:

Enterprise-Level Natural Language to SQL Query Systems: The present disclosure enables business users to query complex relational databases using natural language, producing accurate SQL queries even with multiple tables and intricate joins.

Business Intelligence (BI) and Analytics Tools: The present disclosure integrates with BI dashboards to let non-technical stakeholders derive insights from enterprise databases using natural language, without requiring SQL proficiency.

Data Warehousing & Reporting Platforms: The present disclosure automates ontology and mapping generation for large-scale relational databases, facilitating structured data extraction, reporting, and summarization.

AI-Powered Developer Assistance Tools: The present disclosure assists developers in writing correct and optimized SQL queries by guiding them through ontology and mapping-assisted SPARQL generation.

Domain-Specific Chatbots and Virtual Assistants: The present disclosure equips intelligent assistants with enhanced capabilities to understand business queries and return relevant answers by querying structured databases using semantic understanding.

Education and Training for Data Professionals: The present disclosure may be used as an educational tool to demonstrate how ontologies, mappings, and semantic queries improve data understanding and access in real-world enterprise systems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

We claim:

1. A computer-implemented method of generating knowledge graph of a data repository, the computer-implemented method comprising:
receiving an input data and an access of the data repository;
generating a semantic representation of a data repository schema based on the input data and the data repository using a language model, wherein the semantic representation comprises a plurality of elements, and wherein the semantic representation incorporates domain or task specific logics;
validating the semantic representation syntactically and with respect to the input data;
generating a mapping file of the data repository schema based on the semantic representation and the data repository using the language model, wherein the mapping file comprises a mapping of the plurality of elements of the semantic representation to corresponding elements in the input data; and
validating the mapping file syntactically and semantically based on the semantic representation, data repository and the input data.

2. The computer-implemented method of claim 1, wherein the semantic representation is a graph-based or knowledge-based abstraction of the data repository schema.

3. The computer-implemented method of claim 1, wherein the domain or task specific logics are integrated into the semantic representation based on the input data and the validation of the semantic representation.

4. The computer-implemented method of claim 1, wherein the structural and syntactic integrity of the semantic representation and the mapping file is checked by a plurality of predefined rules.

5. The computer-implemented method of claim 1, wherein the language model is a large language model (LLM) trained to process structured prompts and domain knowledge.

6. The computer-implemented method of claim 1, wherein the semantic representation of the data repository schema is generated by a LLM based ontology generation agent, and wherein the mapping file of the data repository schema is generated by a LLM based mapping generation agent.

7. The computer-implemented method of claim 1, wherein the semantic representation and the mapping file are iteratively refined using feedback loops with the language model until the semantic representation and mapping file meets a predefined validation criterion, and wherein the feedback loops comprises one or more iterations of the validation of the semantic representation and the validation of the mapping file.

8. A system of generating knowledge graph of a data repository, the system comprising:
a processor; and
a memory communicatively coupled to the processor, wherein the memory stores processor-executable instructions, which, on execution, cause the processor to:
receive an input data and an access of the data repository;
generate a semantic representation of a data repository schema based on the input data and the data repository using a language model, wherein the semantic representation comprises a plurality of elements, and wherein the semantic representation incorporates domain or task specific logics;
validate the semantic representation syntactically and with respect to the input data;
generate a mapping file of the data repository schema based on the semantic representation and the data repository using the language model, wherein the mapping file comprises a mapping of the plurality of elements of the semantic representation to corresponding elements in the input data; and
validate the mapping file syntactically and semantically based on the semantic representation, data repository and the input data.

9. The system of claim 8, wherein the semantic representation is a graph-based or knowledge-based abstraction of the data repository schema.

10. The system of claim 8, wherein the domain or task specific logics are integrated into the semantic representation based on the input data and the validation of the semantic representation.

11. The system of claim 8, wherein the structural and syntactic integrity of the semantic representation and the mapping file is checked by a plurality of predefined rules.

12. The system of claim 8, wherein the language model is a Large Language Model (LLM) trained to process structured prompts and domain knowledge.

13. The system of claim 8, wherein the semantic representation of the data repository schema is generated by a LLM based ontology generation agent, and wherein the mapping file of the data repository schema is generated by a LLM based mapping generation agent.

14. The system of claim 8, wherein the semantic representation and the mapping file are iteratively refined using feedback loops with the language model until the semantic representation and mapping file meets a predefined validation criterion, and wherein the feedback loops comprises one or more iterations of the validation of the semantic representation and the validation of the mapping file.

15. A non-transitory computer-readable storage medium having stored thereon computer executable instruction which when executed by one or more processors, cause the one or more processors to carry out a method of generating knowledge graph of a data repository, the method comprising:
receiving an input data and an access of the data repository;
generating a semantic representation of a data repository schema based on the input data and the data repository using a language model, wherein the semantic representation comprises a plurality of elements, and wherein the semantic representation incorporates domain or task specific logics;
validating the semantic representation syntactically and with respect to the input data;
generating a mapping file of the data repository schema based on the semantic representation and the data repository using the language model, wherein the mapping file comprises a mapping of the plurality of elements of the semantic representation to corresponding elements in the input data; and
validating the mapping file syntactically and semantically based on the semantic representation, data repository and the input data.

16. The non-transitory computer-readable storage medium of claim 15, wherein the semantic representation is a graph-based or knowledge-based abstraction of the data repository schema.

17. The non-transitory computer-readable storage medium of claim 15, wherein the domain or task specific logics are integrated into the semantic representation based on the input data and the validation of the semantic representation.

18. The non-transitory computer-readable storage medium of claim 15, wherein the structural and syntactic integrity of the semantic representation and the mapping file is checked by a plurality of predefined rules.

19. The non-transitory computer-readable storage medium of claim 15, wherein the language model is a large language model (LLM) trained to process structured prompts and domain knowledge.

20. The non-transitory computer-readable storage medium of claim 15, wherein the semantic representation and the mapping file are iteratively refined using feedback loops with the language model until the semantic representation and mapping file meets a predefined validation criterion, and wherein the feedback loops comprises one or more iterations of the validation of the semantic representation and the validation of the mapping file.
